(19) United States
(12) Patent Application Publication
(10) Pub. No.: US 2025/0168780 A1
(43) Pub. Date: May 22, 2025

(54) NETWORK ENERGY SAVING CORRELATED WITH QUALITY OF SERVICE

(71) Applicant: Lenovo (Singapore) Pte. Limited, Singapore (SG)

(72) Inventors: Tapisha Soni, Munich (DE); Prateek Basu Mallick, Dreieich (DE); Joachim Löhr, Wiesbaden (DE); Ravi Kuchibhotla, Chicago, IL (US); Karthikeyan Ganesan, Kronberg Im Taunus (DE)

(73) Assignee: Lenovo (Singapore) Pte. Limited, Singapore (SG)

(21) Appl. No.: 18/951,278

(22) Filed: Nov. 18, 2024

Related U.S. Application Data
(60) Provisional application No. 63/600,707, filed on Nov. 19, 2023.

(51) Int. Cl. H04W 52/26; H04W 24/10

(52) U.S. Cl. CPC H04W 52/265; H04W 24/10

(57) ABSTRACT

Various aspects of the present disclosure relate to network energy saving (NES) correlated with quality of service (QoS). An apparatus, such as a user equipment (UE), receives, as a radio resource configuration from a network equipment (NE), an indication of at least one of a NES class or a NES configuration of the NES class. The UE is configured based on the NES configuration or the NES class. A NE determines the NES configuration based on an expected QoS as reported by one or more UE. The NE transmits, as a radio resource configuration to the one or more UE, the NES class or the NES configuration of the NES class.

### RELATED APPLICATION

This application claims priority to U.S. Provisional Application Ser. No. 63/600,707 filed Nov. 19, 2023 entitled “Network Energy Saving Correlated with Quality of Service,” the disclosure of which is incorporated by reference herein in its entirety.

### TECHNICAL FIELD

The present disclosure relates to wireless communications, and more specifically to network energy saving (NES) and expected quality of service (QoS).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, emissions and energy consumption from different elements of the system adversely contribute to the climate, and the operating expenses to run telecommunication services are immense. The increasing use of mobile data traffic will only continue to increase, combined with the rising costs of spectrum, capital investment, and ongoing RAN maintenance and upgrades, energy-saving measures in network operations are needed.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive, as a radio resource configuration from a network equipment (NE), an indication of at least one of a NES class or a NES configuration of the NES class; and configure the UE based on at least one of the NES configuration or the NES class.

In some implementations of the method and apparatuses described herein, the UE receives a mapping of a correspondence between the NES class and a NES profile, the NES profile including the NES configuration of the NES class and the NES class including an attainable QoS. The UE is configured in a radio resource control (RRC) connected mode using RRC signaling, and the UE reports an expected QoS to the NE. The UE is configured in a RRC idle mode, and the UE at least one of prioritizes or down-prioritizes a cell (re)selection of a particular cell based at least in part on the indication of the NES class. The UE is configured in a RRC idle mode, and the UE at least one of prioritizes or down-prioritizes a cell (re)selection of a particular cell based at least in part on the indication of the NES configuration. The NES class indicates an attainable QoS at the UE for a configured NES mode. The UE derives an active time remaining for a cell from at least one of the NES class or the NES configuration. The UE reports an estimated QoS to the NE based on periodic reporting. The UE reports an estimated QoS to the NE based on event-triggered reporting. The UE prioritizes cell (re)selection of a particular cell based at least in part on an active time remaining for the particular cell.

Some implementations of the method and apparatuses described herein may further include a processor for wireless communication to receive, as a radio resource configuration from a NE, an indication of at least one of a NES class or a NES configuration of the NES class; and configure a UE based on at least one of the NES configuration or the NES class.

In some implementations of the method and apparatuses described herein, the processor receives a mapping of a correspondence between the NES class and a NES profile, the NES profile including the NES configuration of the NES class and the NES class including an attainable QoS. The UE is configured in a RRC connected mode, and the processor reports an expected QoS to the NE. The UE is configured in a RRC idle mode, and the processor at least one of prioritizes or down-prioritizes a cell (re)selection of a particular cell based at least in part on the indication of the NES class. The UE is configured in a RRC idle mode, and the processor at least one of prioritizes or down-prioritizes a cell (re)selection of a particular cell based at least in part on the indication of the NES configuration. The NES class indicates an attainable QoS at the UE for a configured NES mode. The processor derives an active time remaining for a cell from at least one of the NES class or the NES configuration. The processor reports an estimated QoS to the NE based on periodic reporting. The processor reports an estimated QoS to the NE based on event-triggered reporting. The processor prioritizes cell (re)selection of a particular cell based at least in part on an active time remaining for the particular cell.

Some implementations of the method and apparatuses described herein may further include a method performed by a UE, the method including receiving, as a radio resource configuration from a NE, an indication of at least one of a NES class or a NES configuration of the NES class; and configuring the UE based on at least one of the NES configuration or the NES class.

In some implementations of the method and apparatuses described herein, the method further comprising receiving a mapping of a correspondence between the NES class and a NES profile, the NES profile including the NES configuration of the NES class and the NES class including an attainable QoS. The UE is configured in a RRC connected mode, and the method further comprising reporting an expected QoS to the NE. The UE is configured in a RRC idle mode, and the method further comprising at least one of prioritizing or down-prioritizing a cell (re)selection based at least in part on the indication of the NES class. The UE is configured in a RRC idle mode, and the method further comprising at least one of prioritizing or down-prioritizing a cell (re)selection based at least in part on the indication of the NES configuration. The NES class indicates an attainable QoS at the UE for a configured NES mode. The method further comprising deriving an active time remaining for a cell from at least one of the NES class or the NES configuration. The method further comprising reporting an estimated QoS to the NE based on periodic reporting. The method further comprising reporting an estimated QoS to the NE based on event-triggered reporting. The method further comprising prioritizing cell (re)selection based at least in part on an active time remaining for a cell.

Some implementations of the method and apparatuses described herein may further include an NE for wireless communication to determine a NES configuration based at least in part on an expected QoS as reported by one or more UE; and transmit, as a radio resource configuration to the one or more UE, at least one of a NES class or the NES configuration of the NES class.

In some implementations of the method and apparatuses described herein, the NE transmits at least one of the NES class or the NES configuration to a neighboring NE. The NE receives an indication of the NES class from a neighboring NE, and determines the NES configuration based at least in part on the indication of the NES class or the NES configuration received from the neighboring NE. The NE determines the NES class based on a mapped correspondence between at least one of a NES profile and a QoS profile, or the NES class and the NES configuration. The NE receives the expected QoS from the one or more UE. The NE receives the expected QoS from the one or more UE as at least one of periodic reporting of the expected QoS or event-triggered reporting of the expected QoS. The NE receives an indication of the NES class from a neighboring NE, and determines the NES configuration based at least in part on the NES class or the NES configuration received from the neighboring NE.

Some implementations of the method and apparatuses described herein may further include a method performed by an NE, the method including determining a NES configuration based at least in part on an expected QoS as reported by one or more UE; and transmitting, as a radio resource configuration to the one or more UE, at least one of a NES class or the NES configuration of the NES class.

In some implementations of the method and apparatuses described herein, the method further comprising transmitting at least one of the NES class or the NES configuration to a neighboring NE. The method further comprising receiving an indication of the NES class from a neighboring NE; and determining the NES configuration based at least in part on the indication of the NES class or the NES configuration received from the neighboring NE. The method further comprising determining the NES class based on a mapped correspondence between at least one of a NES profile and a QoS profile, or the NES class and the NES configuration. The method further comprising receiving the expected QoS from the one or more UE. The method further comprising receiving the expected QoS from the one or more UE as at least one of periodic reporting of the expected QoS or event-triggered reporting of the expected QoS. The method further comprising receiving an indication of the NES class from a neighboring NE; and determining the NES configuration based at least in part on the NES class or the NES configuration received from the neighboring NE.

### BRIEF DESCRIPTION OF THE DRAWINGS

FIG. 1 illustrates an example of a wireless communications system in accordance with aspects of the present disclosure.

FIG. 2 illustrates an example procedure of an advanced AI-based NES call flow, in accordance with aspects of the present disclosure.

FIG. 3 illustrates an example procedure for prioritization or down-prioritization of a cell for an RRC idle UE, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method performed by a UE in accordance with aspects of the present disclosure.

FIG. 8 illustrates a flowchart of a method performed by a NE in accordance with aspects of the present disclosure.

### DETAILED DESCRIPTION

A wireless communications system includes a great many number of components, devices, services, and equipment, many of which contribute to rising network costs and operational expenses. Additionally, the emissions and energy consumption from the many different network elements adversely contribute to the climate. The increasing use of mobile data traffic will only continue to increase, combined with the rising costs of spectrum, capital investment, and ongoing RAN maintenance and upgrades, energy-saving measures in network operations are needed. In particular, new communications use cases and the adoption of mm-Wave will require more sites and antennas. Although this lends to the prospect of a more efficient network, the result will be an increase in emissions without active intervention. As 5G becomes pervasive across industries and geographical areas, handling more advanced services and applications requiring very high data rates, networks are becoming denser, using more antennas, larger bandwidths, and more frequency bands. Implementations of NES can help to control the environmental impact of expanding 5G.

In a wireless communications system, most of the energy consumption is due to the radio access network and in particular, from the active antenna unit (AAU), with data centers and fiber transport accounting for a smaller share of the energy consumption. The power consumption of radio access can be split into two parts, a dynamic part that only consumes power when data transmission and/or reception is ongoing, and a static part during which power is consumed all of the time to maintain the necessary operation of the radio access devices, even when the data transmission and/or reception is not on-going. Power savings techniques are therefore needed, particularly with reference to base stations, for NES and to achieve more efficient operation dynamically and/or semi-statically, with a finer granularity adaptation of transmissions and/or receptions in one or more network energy saving techniques in time, frequency, spatial, and power domains, as well as support and feedback from UEs, potential UE assistance information, and an information exchange and coordination over network interfaces. Any potential network energy consumption gains also need to take into account the impact on network and UE performance by looking at key performance indicators (KPIs) such as spectral efficiency, capacity, user perceived throughput (UPT), latency, UE power consumption, complexity, handover performance, call drop rate, initial access performance, service level agreements (SLA) assurance related KPIs, etc.

Standardized NES capability can improve energy savings, as well as importantly serve the UEs without compromising performance. The diverse use cases from industry verticals lead to different traffic models and service QoS. It may be essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur, such as for example, a cell benefiting from maximum energy saving cannot satisfy latency-critical service requirements of sub-millisecond end-to-end latency for multiple UEs. Such degradation in QoS is intolerable for use cases like augmented reality and/or virtual reality (AR/VR), haptic feedback, autonomous vehicles, mission-critical communication, mobile robots, etc. Hence, an adaptive and robust NES mechanism is implemented to attain an optimal balance. Conventionally, RRC idle and/or inactive UEs are unaware of the NES configuration and the QoS that a cell can serve. They perform the cell selection or reselection irrespective of the NES mode configured and activated in a cell. Additionally, the network configures the NES mode independent of any QoS-relevant feedback from the UE. This can lead to user (e.g., UE) performance degradation and thus service interruption.

Aspects of the disclosure are directed to techniques to mitigate the tradeoff in energy savings and UE performance by incorporating QoS awareness in energy saving mode. This disclosure introduces techniques for a cell to determine the NES mode configuration (e.g., a discontinuous transmission/discontinuous reception (DTX/DRX) configuration) by considering UE-specific expected QoS, and further, solves unfavorable cell selection or reselection for an RRC idle UE due to an NES mode configured in the cell. Further, aspects of the disclosure are directed to implementation of NES-class as a mechanism to incorporate QoS awareness in an NES solution. The expected QoS for upcoming traffic can be determined at the UE as an expected QoS class identifier (QCI) and reported from the UE to the network. A methodology is implemented for NES class selection by the network using the expected QCI report with other traffic measures. The NES class information is reported from neighbor cells to the serving cell. Additionally, NES class may be adapted using the NES class information received from the neighbor cells. Further, a mechanism is implemented to bar non-NES UE and to enable prioritization and/or down-prioritization of NES cells by NES-capable UE. This allows further granularity for barring UEs from NES cells for a balanced energy saving and user performance. Further implementations include broadcast signaling of an NES class in system information using system information SIB4/SIB5.

In aspects of this disclosure, a structure termed NES-class is defined, which constitutes the NES configuration as well as the attainable QoS when in NES mode. A UE reports information on its expected QoS for the upcoming traffic, and the NES class is broadcasted in SIB, which the UE uses in RRC idle and prioritizes the cell that fulfills its QoS requirement. The proposed techniques extend the energy saving mode to RRC idle UEs. Otherwise, an RRC idle UE might connect to any NES cell without being aware of its NES configuration, leading to radio link failure or performance degradation. The network determines the NES configuration using cell load, traffic pattern, etc., however, this does not assure the UE performance for the forthcoming traffic. This disclosure derives a robust solution and complements the legacy behavior. The disclosure further includes an introduction of NES class and its broadcast signaling in SIB indication. A UE reports its expected QoS for the network to perform decisions or determinations on NES configuration. The NES class indication is essential for a UE to prioritize or down-prioritize a cell while considering its configured and activated NES mode.

Aspects of the present disclosure are described in the context of a wireless communications system for NES correlated with QoS.

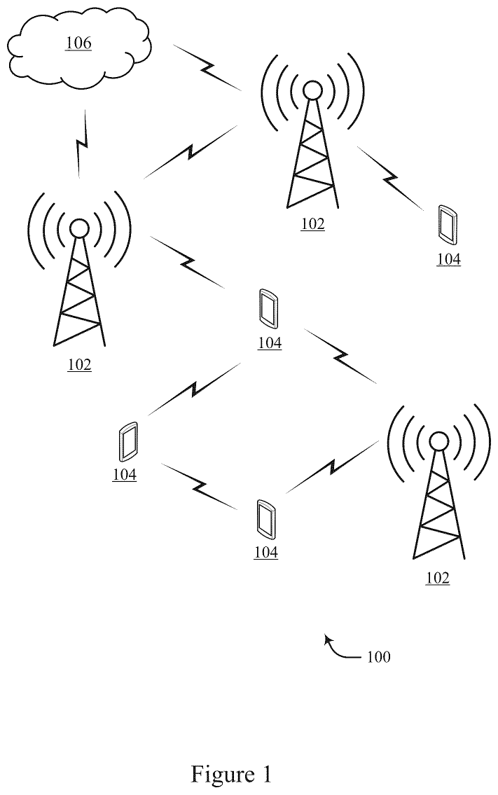

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station, gNB) determines a NES configuration based on an expected QoS as reported by one or more of the UEs 104. The NE 102 transmits, as a radio resource configuration to the one or more UEs 104, a NES class and/or the NES configuration of the NES class. In a further example, a UE 104 receives, as a radio resource configuration from a NE 102, an indication of a NES class and/or a NES configuration of the NES class. The UE 104 configures the UE 104 based on the NES configuration and/or the NES class.

A technique to improve network energy savings in time domain is cell DTX/DRX, which is applicable to UEs in a RRC connected state. A periodic cell DTX/DRX (i.e., active, and non-active periods) can be configured by gNB via UE-specific RRC signaling per serving cell, and cell DTX/DRX can also be configured and operated together. At least the following parameters can be configured per cell DTX/DRX configuration, including periodicity, start slot/offset, and on duration. UE behavior is a focus when, at any point in time, the cell activates a single DTX/DRX configuration. It is up to network whether legacy UEs in an idle mode can access cells with cell DTX/DRX and the network should be able to allow NES-capable UEs to camp on the NES cell. The cell DTX/DRX mode can be activated or deactivated via dynamic L1/L2 signaling and UE-specific RRC signaling. Both UE specific and common L1/L2 signaling can be considered for activating and deactivating the cell DTX/DRX mode. In implementations, the NES capable UEs can be configured to (de)prioritize NES cells, and take into account both frequency and cell levels cell selection/reselection (de)prioritization, as well as separate camping restrictions for NES-capable and non-NES UEs.

With reference to NES correlated with QoS, as described herein, an implementation (i.e., first implementation) includes a mechanism referred to as “NES class” which is used to mitigate the challenge arising from the tradeoff in energy savings and demanding KPIs. The NES class is defined as the identifier of the amount of energy saving. To incorporate QoS awareness into energy saving solutions, the NES class is mapped to an NES profile and a QoS profile, which can each be defined. The NES profile includes an NES configuration (i.e., the radio resource configuration), such as a cell DTX/DRX configuration (periodicity, on-duration, offset) and an energy cost metric used to represent energy saving and/or consumption. The QoS profile includes the highest attainable QoS for the respective NES configuration as represented by a QCI of the NES-class. The table below is an example definition of NES class and describes a list of NES class which is either pre-defined or configured dynamically. One NES class may be mapped to one or more radio resource configurations (NES configurations). The NES class definition can be extended with additional factors if they become relevant to the NES features.

TABLE
NES class mapping to QoS profile

| NES-class | NES Profile | | QoS Profile |
|---|---|---|---|
| NES-class | NES configuration | Energy cost | Highest QCI |
| 0 | No NES mode is applicable | | |
| 1 | configuration - 1 | Energy cost - 1 | QCI-1 |
| | configuration - 2 | | |
| | . . . | | |
| 2 | configuration - 3 | Energy cost - 2 | QCI-2 |
| | . . . | | |
| 3 | configuration - 4 | Energy cost - 3 | QCI-3 |
| . | . . . | . | . |
| . | . . . | . | . |
| N | configuration - N | Energy cost - N | . |

In aspects of another implementation (i.e., second implementation), a UE determines the expected QoS for the upcoming traffic, which is represented in the form of “expected QCI” using intelligent QoS prediction methodology. One of the following common QoS prediction techniques can be applied to generate the expected QCI on the UE side. For the nearest neighborhood technique, a QoS prediction is performed based on the similarity, if the similarity factor in QoS experiences of services is higher, a comparable QoS is estimated for upcoming services. For the maximum factorization technique, a service QoS is predicted using all past QoS data to train and learn the implicit feature matrix of user-service relation. For a deep learning technique, a time series model, such as the long short-term memory (LSTM) model, uses the expected correlation in historic QoS samples that are equally distributed and indexed in time. The choice of QoS prediction algorithm is up to the UE implementation in order to derive its expected QCI. For example, a UE can be configured with either a QoS-tolerant or QoS-intolerant prediction procedure, and thus the expected QCI is generated based on the stringency desired in terms of QoS requirement and the flexibility of QoS.

In aspects of another implementation (i.e., third implementation), and with reference to legacy, the NES mode (i.e., cell DTX/DRX mode) is designed for RRC connected UEs. The network determines the cell DTX/DRX configuration depending on the traffic load, a number of UEs, etc., configures the DTX/DRX configuration, and signals the configuration to the UE via dedicated RRC signaling. Group common L1/L2 signaling is used to activate and deactivate the energy saving mode.

For QoS-relevant reporting, from a UE, complementary to the legacy, the network can benefit from UE reporting on predicted QoS measures such that a QoS-aware energy saving setting is configured. For this purpose, the UE reports its expected QCI to the network along with the legacy measurement report. This expected QCI is determined by the UE as per the second implementation described above. In an RRC connected state, the UE can be configured to perform QoS-relevant data collection and training, via dedicated signaling. The network may configure the UE to report the expected QCI based on periodic reporting or event-triggered reporting.

The RRC configures a parameter called periodicQCI_timer to control the expected QCI reporting procedure. An expected QCI report is triggered if the periodicQCI_timer expires, which is referred to as periodic expected QCI. Alternative to periodic reporting, regular expected QCI reporting is triggered when uplink (UL) data becomes available at the medium access control (MAC) entity. In one example UE triggers the reporting of an expected QCI MAC control element (CE) when the content of the MAC CE has changed compared to the previously reported MAC CE (e.g., the predicted QCI information has changed). A further enhancement can regulate the regular expected QCI reporting to be triggered when UL data for predefined logical channel group (LCG) with a higher priority becomes available. The MAC entity should include the expected QCI MAC CE in the MAC PDU in accordance with the configuration by the RRC. According to one implementation, a scheduling request (SR) configuration is associated with the expected QCI MAC CE. In one example, a UE triggers an SR for cases where the expected QCI MAC CE was triggered, but the UE has no available UL grant or physical uplink shared channel (PUSCH) resources. Triggering an SR for the new MAC CE will allow for early notification to gNB that there is some pending expected QCI information and/or MAC CE pending in the UE for transmission.

Alternatively, the expected QCI reporting is included in the UE assistance information. In one example, a new type of assistance information is signaled as part of the UE assistance information (e.g., NES-related UE assistance information). When configured to do so, the UE capable of providing its preferred QoS requirement in terms of expected QCI in RRC connected can signal the network through the UE assistance information (UAI). This indicates to the network whether the UE is willing to tolerate a potential NES configuration or to what extent can the UE tolerate the NES level. This in turn points to the potential upcoming UE data traffic and thus its respective QoS. Additionally, neighbor gNBs can share their NES class with the serving gNB to facilitate optimal selection of the NES class, and thus the NES configuration (elaborated below).

With reference to NES class, creation, and selection, the network performs NES-class selection using the reporting from the UE and the neighbor gNBs. In legacy, a gNB determines the NES configuration based on parameters like cell load, traffic pattern, etc., for instance, different thresholds of cell load are used for cell switch on/off. When no QoS-relevant reporting from a UE is available, one simple way to generate NES class is that the network associates the NES configuration selected by a legacy procedure to the highest attainable QoS, and thus creates an appropriate NES-QoS profile, assuming that the network is aware of its QoS capabilities.

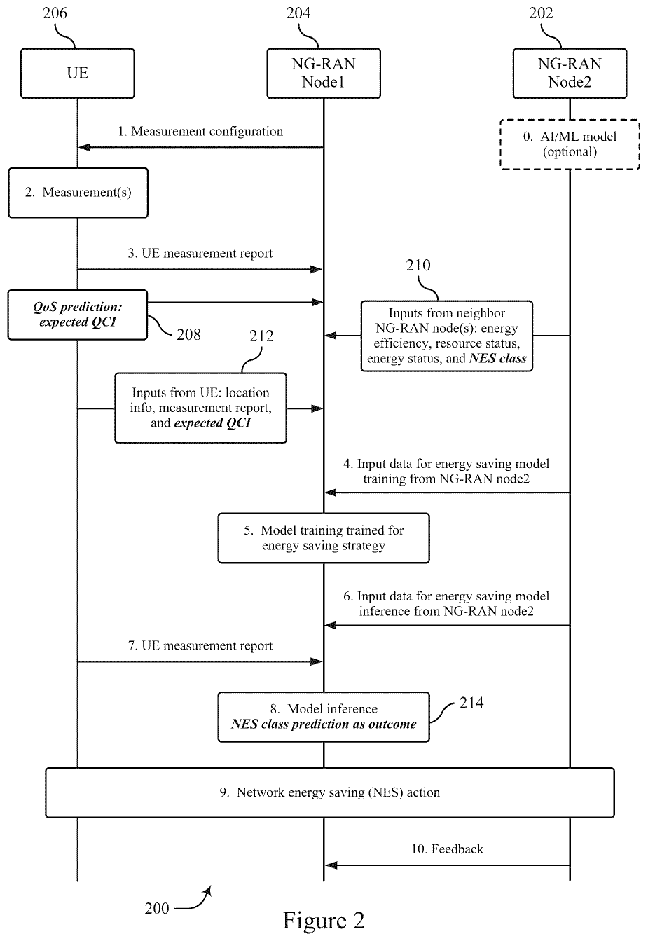

FIG. 2 illustrates an example procedure 200 of an advanced AI-based NES call flow, in accordance with aspects of the present disclosure. When the UE capability supports QoS-relevant reporting, the network determines the NES class as an outcome of an intelligent NES solution enabled by artificial intelligence (AI) model training and inference. The example procedure 200 is representative of agreed existing AI-based NES solutions, with additional aspects of the described techniques added to implement the features of NES correlated with QoS, as described herein. The serving cell receives inputs such as energy efficiency, resource status, and energy status (low, high) from the neighbor gNBs and location information and measurement reports from the UE. However, for a flawless service experience, additional QoS-relevant measures are included.

At step 0 (zero) of the procedure, an NG-RAN node2 (identified as 202) is optionally assumed to have an AI/ML model (artificial intelligence/machine learning model), and the NG-RAN node2 can provide an NG-RAN node1 (identified as 204) with input information. At step 1 (one) of the procedure, the NG-RAN node1 configures the measurement information on the UE side and sends (communicates, transmits) a measurement configuration message to the UE (identified as 206) to perform a measurement procedure and reporting. At step 2 (two) of the procedure, the UE collects the indicated measurement(s) (e.g., UE measurements related to reference signal received power (RSRP), reference signal received quality (RSRQ), and signal-to-interference plus Noise Ratio (SINR) of a serving cell and neighboring cells. At step 3 (three) of the procedure, the UE sends (communicates, transmits) the measurement report(s) to the NG-RAN node1 including the required measurement result.

Considering the AI-based NES framework as the baseline, the UE 206 reports the expected QCI measure to the network at 208, and at 210, the neighbor gNBs (e.g., NG-RAN node2 202) share their NES class with the serving gNB (e.g., NG-RAN node1 204). The expected QCI from UE and the NES class from neighbor gNBs are provided as input, in addition to the other parameters at 212, for AI-NES model training at the network. At step 4 (four) of the procedure, the NG-RAN node2 sends the required input data to NG-RAN node 1 for model training of the AI/ML-based network energy saving. Thus, the AI-NES model is trained using inputs such as cell load, traffic pattern, expected QCI, NES-class from neighbor cells, and past NES configurations. At step 5 (five) of the procedure, the NG-RAN node1 trains the AI/ML model for the AI/ML-based energy saving based on the collected data. The NG-RAN node2 is assumed (optionally) to have an AI/ML model for AI/ML-based energy saving, which can also generate predicted results and actions. The NES-class is therefore determined as an outcome of the AI-NES model inference. For example, traditional cell sleep modes are applied using static thresholds which are set manually, whereas an intelligent solution provides cell sleep modes using dynamic thresholds by taking into account the QoS-relevant reporting and feedback from the UE, as well as from neighbor gNBs.

At step 6 (six) of the procedure, the NG-RAN node2 sends (communicates, transmits) the required input data to the NG-RAN node1 for model inference of the AI/ML-based network energy saving. At step 7 (seven) of the procedure, the UE sends (communicates, transmits) the UE measurement report(s) to NG-RAN node1. At step 8 (eight), and based on local inputs of the NG-RAN node 1 and the received inputs from NG-RAN node2, the NG-RAN node 1 generates a model inference output (e.g., energy saving strategy, handover strategy, etc), as well as an NES class prediction as outcome at 214. At step 9 (nine) of the procedure, the NG-RAN node1 executes the NES actions according to the model inference output. The NG-RAN node1 may select the most appropriate target cell for each UE before it performs a handover, if the output is handover strategy. At step 10 (ten) of the procedure, the NG-RAN node2 provides feedback to the NG-RAN node1.

In aspects of another implementation (i.e., fourth implementation), the NES mode is limited to RRC connected UEs, however, it is essential to consider the effect of energy savings on the UE in an RRC idle mode. When in the RRC idle mode, a UE performs cell selection or reselection without any knowledge of the energy saving mode configured or activated in the respective candidate cells. This can lead to UEs connecting to NES cells and experiencing performance degradation unacceptable for stringent service categories.

To circumvent unwanted radio link failure and to ease the process of cell selection or reselection, the network signals the NES class indication as broadcast in the system information (SIB4/SIB5). Upon reception of the SIB1 indication for cell-specific SIB4/SIB5, the UE decodes the NES class indication and thus, the attainable QCI associated with the respective NES class configured and activated in the cell. The UE expected QCI is taken as a threshold to evaluate whether QoS can be served by a cell or not. Consequently, a cell is prioritized or down-prioritized for cell selection or reselection, as shown and described with reference to FIG. 2. The legacy (re)selection always serves as a baseline solution if energy saving mode is not enabled. The UE performs this cell (re)selection in NES mode using the proposed QoS-aware scheme if configured and enabled.

When the cell is in an NES mode, a non-NES UE can access the cell only if the NES solution is backward compatible. The NES cell is configurable as to whether to bar legacy UEs in the RRC idle mode. While the network allows NES capable UEs to camp on the NES cell, it can configure these UEs to prioritize or deprioritize NES cells. It is important to focus on camping restrictions for non-NES and NES capable UEs.

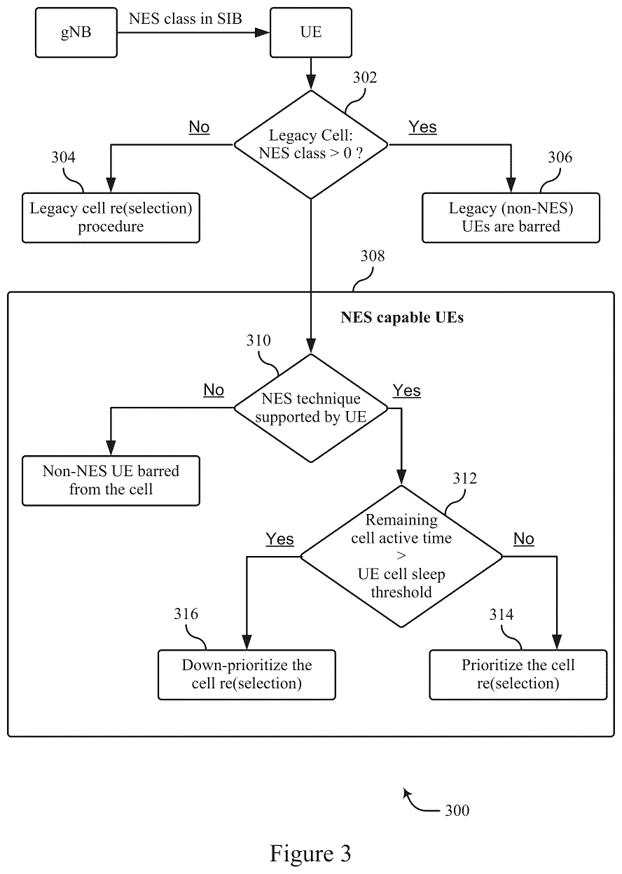

FIG. 3 illustrates an example procedure 300 for prioritization or down-prioritization of a cell for an RRC idle UE, in accordance with aspects of the present disclosure. The NES class indication resolves the concern of barring UEs from NES cells and especially, barring NES capable UEs from NES cells. At 302 in the procedure, a determination is made as to whether a legacy cell NES class is greater than zero. If the NES class is set to zero, it implies that no NES feature is enabled in the cell, and any type of UE can access the cell. If the NES class=0, then no NES solution is applied and therefore at 304, the legacy or existing cell selection or reselection is performed. If NES class is greater than zero, then at 306, the legacy UE is barred from the cell, and the specific NES class indication informs the UE about the NES features enabled and the respective supported QoS. If the NES class>0, this implies that the NES solution is applied, and there are two possibilities, including (A), the UE is a legacy (Release 18) UE or a UE not supporting NES (non-NES UE), in which case the UE will be barred, meaning not allowed to connect to the cell; or (B), for all other UEs, this indicates that the UE is not a legacy or non-NES UE, but rather is an NES capable UE.

For NES capable UEs 308, a determination is made as to whether an NES technique is supported by the UE at 310. If “yes”, then a determination is made as to whether the remaining cell active time is greater than the UE cell sleep threshold at 312. The remaining cell active time is the remaining time for which the cell will be in the active state. The UE cell sleep threshold is a predefined threshold for cell sleep time from the UE perspective, which is used to evaluate whether the remaining active time of the cell is sufficient for the UE to avoid radio link failure.

For an NES-capable UE, if the configured NES technique is supported by the UE, then the UE prioritizes the cell at 314 if the remaining active time of the cell is greater than the UE cell sleep threshold. This enables better barring granularity for the NES-capable UE. This mechanism assists the UE in its cell selection or reselection process, which is beneficial to the NES-capable UE to filter the candidate target cells and select the most suitable cell, otherwise an acceptable cell. One aspect of the technique is to broadcast the NES class in the system information (SIB4/SIB5) and derive an optimal trade-off for NES gains and UE performance. Otherwise at 316, the cell re(selection) is down-prioritized.

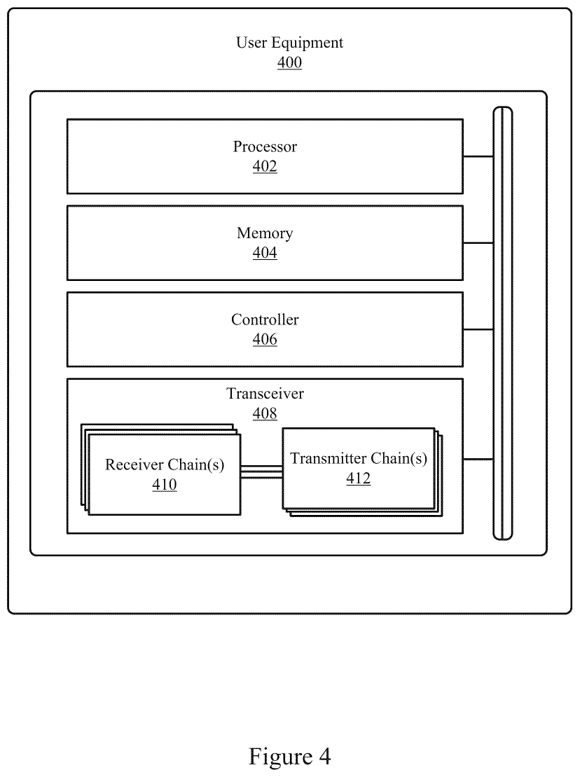

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving, as a radio resource configuration from a NE, an indication of at least one of a NES class or a NES configuration of the NES class; and configuring the UE based on at least one of the NES configuration or the NES class.

Additionally, the UE 400 may be configured to support any one or combination of the method further comprising receiving a mapping of a correspondence between the NES class and a NES profile, the NES profile including the NES configuration of the NES class and the NES class including an attainable QoS. The UE is configured in a RRC connected mode, and the method further comprising reporting an expected QoS to the NE. The UE is configured in a RRC idle mode, and the method further comprising at least one of prioritizing or down-prioritizing a cell (re)selection based at least in part on the indication of the NES class. The UE is configured in a RRC idle mode, and the method further comprising at least one of prioritizing or down-prioritizing a cell (re)selection based at least in part on the indication of the NES configuration. The NES class indicates an attainable QoS at the UE for a configured NES mode. The method further comprising deriving an active time remaining for a cell from at least one of the NES class or the NES configuration. The method further comprising reporting an estimated QoS to the NE based on periodic reporting. The method further comprising reporting an estimated QoS to the NE based on event-triggered reporting. The method further comprising prioritizing cell (re)selection based at least in part on an active time remaining for a cell.

Additionally, or alternatively, the UE 400 may support at least one memory and at least one processor coupled with the at least one memory and configured to cause the UE to receive, as a radio resource configuration from a NE, an indication of at least one of a NES class or a NES configuration of the NES class; and configure the UE based on at least one of the NES configuration or the NES class.

Additionally, the UE 400 may be configured to support any one or combination of the at least one processor is configured to cause the UE to receive a mapping of a correspondence between the NES class and a NES profile, the NES profile including the NES configuration of the NES class and the NES class including an attainable QoS. The UE is configured in a RRC connected mode, and the at least one processor is configured to cause the UE to report an expected QoS to the NE. The UE is configured in a RRC idle mode, and the at least one processor is configured to cause the UE to at least one of prioritize or down-prioritize a cell (re)selection of a particular cell based at least in part on the indication of the NES class. The UE is configured in a RRC idle mode, and the at least one processor is configured to cause the UE to at least one of prioritize or down-prioritize a cell (re)selection of a particular cell based at least in part on the indication of the NES configuration. The NES class indicates an attainable QoS at the UE for a configured NES mode. The at least one processor is configured to cause the UE to derive an active time remaining for a cell from at least one of the NES class or the NES configuration. The at least one processor is configured to cause the UE to report an estimated QoS to the NE based on periodic reporting. The at least one processor is configured to cause the UE to report an estimated QoS to the NE based on event-triggered reporting. The at least one processor is configured to cause the UE to prioritize cell (re)selection of a particular cell based at least in part on an active time remaining for the particular cell.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

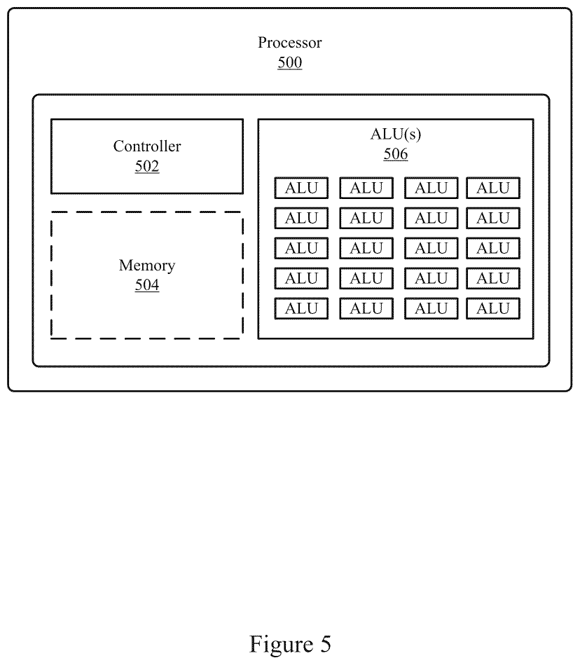

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller coupled with at least one memory and configured to cause the processor to receive, as a radio resource configuration from a NE, an indication of at least one of a NES class or a NES configuration of the NES class; and configure a UE based on at least one of the NES configuration or the NES class.

Additionally, the processor 500 may be configured to or operable to support any one or combination of the at least one controller is configured to cause the processor to receive a mapping of a correspondence between the NES class and a NES profile, the NES profile including the NES configuration of the NES class and the NES class including an attainable QoS. The UE is configured in a RRC connected mode, and the at least one controller is configured to cause the processor to report an expected QoS to the NE. The UE is configured in a RRC idle mode, and the at least one controller is configured to cause the processor to at least one of prioritize or down-prioritize a cell (re)selection of a particular cell based at least in part on the indication of the NES class. The UE is configured in a RRC idle mode, and the at least one controller is configured to cause the processor to at least one of prioritize or down-prioritize a cell (re)selection of a particular cell based at least in part on the indication of the NES configuration. The NES class indicates an attainable QoS at the UE for a configured NES mode. The at least one controller is configured to cause the processor to derive an active time remaining for a cell from at least one of the NES class or the NES configuration. The at least one controller is configured to cause the processor to report an estimated QoS to the NE based on periodic reporting. The at least one controller is configured to cause the processor to report an estimated QoS to the NE based on event-triggered reporting. The at least one controller is configured to cause the processor to prioritize cell (re)selection of a particular cell based at least in part on an active time remaining for the particular cell.

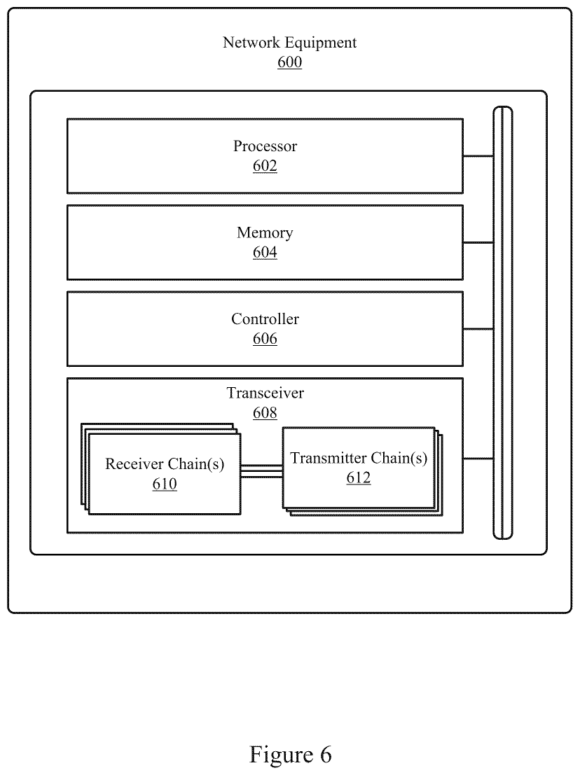

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for determining a NES configuration based at least in part on an expected QoS as reported by one or more UE; and transmitting, as a radio resource configuration to the one or more UE, at least one of a NES class or the NES configuration of the NES class.

Additionally, the NE 600 may be configured to or operable to support any one or combination of the method further comprising transmitting at least one of the NES class or the NES configuration to a neighboring NE. The method further comprising receiving an indication of the NES class from a neighboring NE; and determining the NES configuration based at least in part on the indication of the NES class or the NES configuration received from the neighboring NE. The method further comprising determining the NES class based on a mapped correspondence between at least one of a NES profile and a QoS profile, or the NES class and the NES configuration. The method further comprising receiving the expected QoS from the one or more UE. The method further comprising receiving the expected QoS from the one or more UE as at least one of periodic reporting of the expected QoS or event-triggered reporting of the expected QoS. The method further comprising receiving an indication of the NES class from a neighboring NE; and determining the NES configuration based at least in part on the NES class or the NES configuration received from the neighboring NE.

Additionally, or alternatively, the NE 600 may support at least one memory and at least one processor coupled with the at least one memory and configured to cause the NE to determine a NES configuration based at least in part on an expected QoS as reported by one or more UE; and transmit, as a radio resource configuration to the one or more UE, at least one of a NES class or the NES configuration of the NES class.

Additionally, the NE 600 may be configured to support any one or combination of the at least one processor is configured to cause the NE to transmit at least one of the NES class or the NES configuration to a neighboring NE. The at least one processor is configured to cause the NE to receive an indication of the NES class from a neighboring NE, and determine the NES configuration based at least in part on the indication of the NES class or the NES configuration received from the neighboring NE. The at least one processor is configured to cause the NE to determine the NES class based on a mapped correspondence between at least one of a NES profile and a QoS profile, or the NES class and the NES configuration. The at least one processor is configured to cause the NE to receive the expected QoS from the one or more UE. The at least one processor is configured to cause the NE to receive the expected QoS from the one or more UE as at least one of periodic reporting of the expected QoS or event-triggered reporting of the expected QoS. The at least one processor is configured to cause the NE to receive an indication of the NES class from a neighboring NE, and determine the NES configuration based at least in part on the NES class or the NES configuration received from the neighboring NE.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

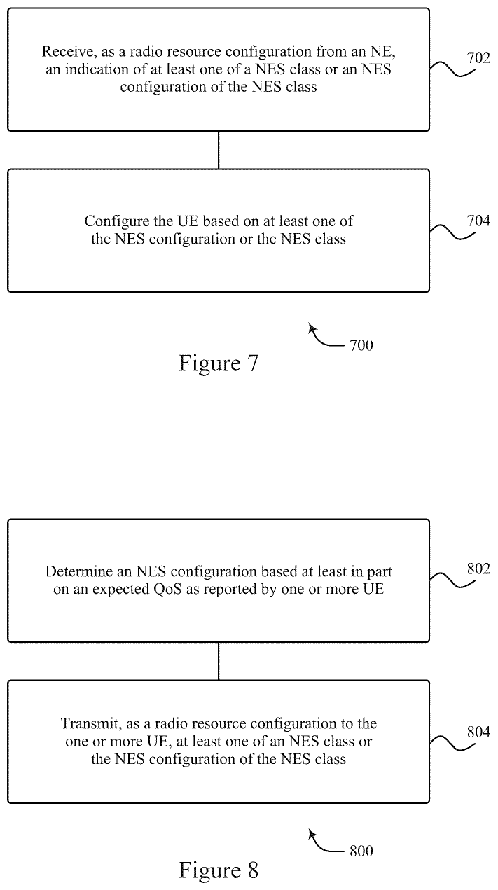

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving, as a radio resource configuration from a NE, an indication of at least one of a NES class or a NES configuration of the NES class. The operations of 702 may be performed in accordance with examples as described herein. In some implementations, aspects of the operations of 702 may be performed by a UE as described with reference to FIG. 4.

At 704, the method may include configuring the UE based on at least one of the NES configuration or the NES class. The operations of 704 may be performed in accordance with examples as described herein. In some implementations, aspects of the operations of 704 may be performed by a UE as described with reference to FIG. 4.

FIG. 8 illustrates a flowchart of a method 800 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include determining a NES configuration based at least in part on an expected QoS as reported by one or more UE. The operations of 802 may be performed in accordance with examples as described herein. In some implementations, aspects of the operations of 802 may be performed by a NE as described with reference to FIG. 6.

At 804, the method may include transmitting, as a radio resource configuration to the one or more UE, at least one of a NES class or the NES configuration of the NES class. The operations of 804 may be performed in accordance with examples as described herein. In some implementations, aspects of the operations of 804 may be performed by a NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, as a radio resource configuration from a network equipment (NE), an indication of at least one of a network energy saving (NES) class or a NES configuration of the NES class; and
configure the UE based on at least one of the NES configuration or the NES class.

2. The UE of claim 1, wherein the at least one processor is configured to cause the UE to receive a mapping of a correspondence between the NES class and a NES profile, the NES profile including the NES configuration of the NES class and the NES class including an attainable quality of service (QoS).

3. The UE of claim 1, wherein the UE is configured in a radio resource control (RRC) connected mode using RRC signaling, and the at least one processor is configured to cause the UE to report an expected quality of service (QoS) to the NE.

4. The UE of claim 1, wherein the UE is configured in a radio resource control (RRC) idle mode, and the at least one processor is configured to cause the UE to at least one of prioritize or down-prioritize a cell (re)selection of a particular cell based at least in part on the indication of one of the NES class or the NES configuration.

5. The UE of claim 1, wherein the NES class indicates an attainable quality of service (QoS) at the UE for a configured NES mode.

6. The UE of claim 1, wherein the at least one processor is configured to cause the UE to derive an active time remaining for a cell from at least one of the NES class or the NES configuration.

7. The UE of claim 1, wherein the at least one processor is configured to cause the UE to report an estimated quality of service (QoS) to the NE based on at least one of periodic reporting or event-triggered reporting.

8. The UE of claim 1, wherein the at least one processor is configured to cause the UE to prioritize cell (re)selection of a particular cell based at least in part on an active time remaining for the particular cell.

9. A processor for wireless communication, comprising:
at least one controller coupled with at least one memory and configured to cause the processor to:
receive, as a radio resource configuration from a network equipment (NE), an indication of at least one of a network energy saving (NES) class or a NES configuration of the NES class; and
configure a user equipment (UE) based on at least one of the NES configuration or the NES class.

10. The processor of claim 9, wherein the at least one controller is configured to cause the processor to receive a mapping of a correspondence between the NES class and a NES profile, the NES profile including the NES configuration of the NES class and the NES class including an attainable quality of service (QoS).

11. The processor of claim 9, wherein the UE is configured in a radio resource control (RRC) connected mode, and the at least one controller is configured to cause the processor to report an expected quality of service (QoS) to the NE.

12. The processor of claim 9, wherein the UE is configured in a radio resource control (RRC) idle mode, and the at least one controller is configured to cause the processor to at least one of prioritize or down-prioritize a cell (re)selection of a particular cell based at least in part on the indication of one of the NES class or the NES configuration.

13. The processor of claim 9, wherein the NES class indicates an attainable quality of service (QoS) at the UE for a configured NES mode.

14. The processor of claim 9, wherein the at least one controller is configured to cause the processor to report an estimated quality of service (QoS) to the NE based on at least one of periodic reporting or event-triggered reporting.

15. The processor of claim 9, wherein the at least one controller is configured to cause the processor to prioritize cell (re)selection of a particular cell based at least in part on an active time remaining for the particular cell.

16. A method performed by a user equipment (UE), the method comprising:
receiving, as a radio resource configuration from a network equipment (NE), an indication of at least one of a network energy saving (NES) class or a NES configuration of the NES class; and
configuring the UE based on at least one of the NES configuration or the NES class.

17. The method of claim 16, further comprising receiving a mapping of a correspondence between the NES class and a NES profile, the NES profile including the NES configuration of the NES class and the NES class including an attainable quality of service (QoS).

18. The method of claim 16, wherein the UE is configured in a radio resource control (RRC) connected mode, and the method further comprising reporting an expected quality of service (QoS) to the NE.

19. A network equipment (NE) for wireless communication, comprising:
at least one memory; and
at least one processor coupled with the at least one memory and configured to cause the NE to:
determine a network energy saving (NES) configuration based at least in part on an expected quality of service (QoS) as reported by one or more user equipment (UE); and
transmit, as a radio resource configuration to the one or more UE, at least one of a NES class or the NES configuration of the NES class.

20. The NE of claim 19, wherein the at least one processor is configured to cause the NE to receive an indication of the NES class from a neighboring NE, and determine the NES configuration based at least in part on the NES class or the NES configuration received from the neighboring NE.
